(19) United States
(12) Patent Application Publication
(10) Pub. No.: US 2011/0284812 A1
(43) Pub. Date: Nov. 24, 2011

(54) METHOD FOR INSTALLING A DOUBLE BEARING IN A CASTING, WHEEL COMPRISING A DOUBLE BEARING, AND JOINT WITH DOUBLE BEARING

(75) Inventor: Erik LINDFORS, Vantaa (FI)

(73) Assignee: KONE CORPORATION, Helsinki (FI)

(21) Appl. No.: 13/177,383

(22) Filed: Jul. 6, 2011

Related U.S. Application Data
(63) Continuation of application No. PCT/FI2010/000010, filed on Feb. 9, 2010.

(30) Foreign Application Priority Data
Feb. 10, 2009 (FI) 20090042

(51) Int. Cl. F16H 55/34; F16C 19/06; F16C 19/54; B29C 39/10

(52) U.S. Cl. 254/416; 264/277; 384/490

(57) ABSTRACT

A method for installing a casting double bearing in a casting, and a wheel manufactured according to the method are provided. The double bearing includes at least two bearing units that are essentially similar. The method includes at least the following phases: a double bearing is formed by disposing two bearings next to each other side-by-side and by placing a separator that forms a gap between the bearings such that the separator rests on at least one of outer surface of the outer rim of a bearing, and the separator part of the separator is disposed between the side surfaces that face each other of the outer rims of the bearings; the formed double bearing is placed in the casting mold in the correct position; and the casting is cast around the double bearing

The present invention relates to a method for installing a double bearing in a casting as defined in the preamble of claim 1, a wheel comprising a double bearing as defined in the preamble of claim 5, and a joint with a double bearing as defined in the preamble of claim 15.

The use of one ball bearing in essentially narrow wheels, such as in the diverting pulleys used in elevators, the bearing wheels used in escalators or in other corresponding wheels or supporting bearings, might cause problems. A problem can arise from the fact that the load carrying capacity of a ball bearing is limited, so that a bearing that is unnecessarily large must be selected according to the load carrying capacity to be a ball bearing, in which case also the shaft to be disposed in the bearing is unnecessarily robust. Another problem is that the raceway of an individual ball bearing is not quite straight, but instead some side pull is produced in the ball bearing and via it, among other things, some extra wear.

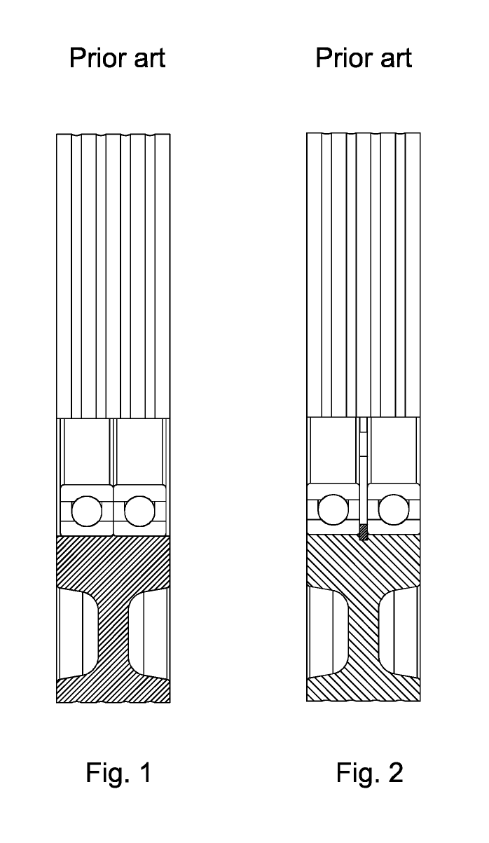

It has been endeavored to solve the load carrying capacity problem and raceway problem by disposing two ball bearings side-by-side as a so-called double bearing. The solution of FIG. 1 presents this type of prior-art solution, which presents a cast diverting pulley provided with rope grooves with the bottom part cross-sectioned. Two similar ball bearings placed side-by-side to each other are disposed in the hub of the wheel, the inner surfaces of which ball bearings are touching each other. The bearings are either installed in the hub of the wheel after casting or the wheel is cast directly around the bearings.

If installation of the bearings is performed after casting, one problem is generally an expensive price, because in this case a lot of work phases are needed. In addition, according to the instruction of the bearing manufacturer, special bearings that are fitted to each other should be used as a double bearing, which are expensive. If it is not desired to use expensive bearings for cost reasons, the bearings can be selected to be larger than normal, which however again raises the price and changes e.g. the shaft structures.

If, on the other hand, the wheel is cast around the bearings, a problem when using normal bearings is the tolerance in the axial direction, i.e. in the width direction of the bearings, which can be so large that the inner rims of the bearings can be wider than the outer rims. In this case, e.g. when making a wheel by die-casting, the die-casting mold presses the outer rims of the bearings together, even if the inner rims were wider than the outer rims. The result in this case might be bearing damage.

Efforts have been made to solve this problem also by placing suitable spacer plates into the bearing housing for forming a gap in the inner rim of the bearings before casting. The positioning of these types of unattached spacer plates in the mold before casting is, however, extremely awkward in die casting technology.

FIG. 2 presents a second solution according to prior art. In it a wheel is first cast, after which a bearing housing is machined, and finally a groove that functions as a hole lock is machined in the center of the rim of the bearing housing. After this the spacer ring is placed into position and the ball bearings an both sides of it, in which case a gap that is the thickness of the spacer ring remains between the inner surfaces of the bearings. This is a technically viable method, but the numerous machining phases make the solution in practice too expensive to manufacture.

The object of this invention is to eliminate the aforementioned drawbacks and to achieve a simple, operationally reliable and inexpensive method for installing a double bearing in a casting. Additionally the purpose of the invention is to achieve a very functional and inexpensive wheel that comprises a double bearing. The method according to the invention is characterized by what is disclosed in the characterization part of claim 1. Correspondingly, the wheel according to the invention is characterized by what is disclosed in the characterization part of claim 5. The joint according to the invention is characterized by what is disclosed in the characterizing part of claim 15. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can in at least some situations be deemed to be inventive in their own right.

In practice a good solution to do for a double-bearing wheel is to dispose a ring-like separator means between the bearing units of the double bearing, which separator means for the first part is supporting the bearing unit by its outer rim and for the second part the bearing units from each other, and a thick gap of the thickness of the separating part of the bearings remains between the bearing units. The gap is always arranged to be so large so that although the outer rims of the bearing units of the double bearing are in connection with each other, possibly via a very thin separator means, the inner rims of the bearing units stay separate from each other. In practice the tolerances of the dimensions of the inner and outer rims of the bearing units in the direction of the shaft of the bearing set the minimum thickness of the separator part.

The solution according to the invention is suited to all types of rotating elements provided with bearings and more particularly e.g. to diverting pulleys used in elevators, bearing wheels used in escalators or other corresponding wheels and support bearings, Likewise instead of the die-casting described in the embodiment, other casting methods are suited for use in the solution according to the invention, e.g. pour casting.

The invention can be advantageously applied such that the separator means that comes between the bearing units of the double bearing is of essentially the same material as the casting cast around the double bearing.

The separator means of a double bearing made for a wheel or other piece can be of metal, plastic or some other suitable material. It can also be of such a material that the separator means melts partly or wholly in connection with the casting into the material of the wheel or other piece to be cast. Preferably the separator means is of essentially the same material as the casting to be cast, e.g. a wheel. When using thermoplastic materials or correspondingly used materials, when making a cast by means of a melting separator means it is preferable to fit the amount and temperature of the material to be cast in relation to the natural cooling and/or aided cooling of the piece being manufactured such that the separator means melts sufficiently to form with the cooled casting material a uniform entity, preferably without interfaces between them, but wherein the separator means is on the other hand unmelted and thus retains during the casting its load bearing capacity for positioning the bearings to each other. Correspondingly, when using a casting material that is hardened chemically or otherwise separately, e.g. with UV light, it might be necessary to chemically or otherwise soften the surface of the separator means that will be on the side of the cast. Thus, in this way the separator means melts or softens first, possibly mixes with or at least forms an essentially borderless joint with, the casting and then hardens again as the casting hardens.

One advantage of the solution according to the invention is that the bearing rims are not damaged in the casting phase, e.g. in the die-casting, because the inner rims of the bearings do not manage to touch each other, even with cheap bearings. Additionally, in this way cheaper and smaller bearings can safely be used as double bearings, in which case the manufacturing costs decrease. Likewise the reliability improves because double bearings can be put into use at smaller costs and thus larger single bearings, in which also there is the aforementioned side-pull problem, will not need to be used. Another advantage is that e.g. in robotic production there will be fewer bearings dropped because the bearings can be attached to each other before the casting.

The invention can also be applied to the making of a joint with bearing. In this case the bearings are cast from their outer rim into the second of the pieces to be jointed, in a corresponding manner to what is presented in this application for making a double bearing in a cast wheel. The tenets relating to the making of a wheel and wheel bearing presented in this application are directly transferable to the bearing of a joint and to making a joint bearing.

In the following, the invention will be described in greater detail by the aid of some embodiments and by referring to the attached simplified drawings, wherein

FIG. 1 presents one prior-art cast diverting pulley that is provided with rope grooves, as viewed from the side and with the bottom part cross-sectioned,

FIG. 2 presents a second prior-art cast diverting pulley that is provided with rope grooves, as viewed from the side and with the bottom part cross-sectioned,

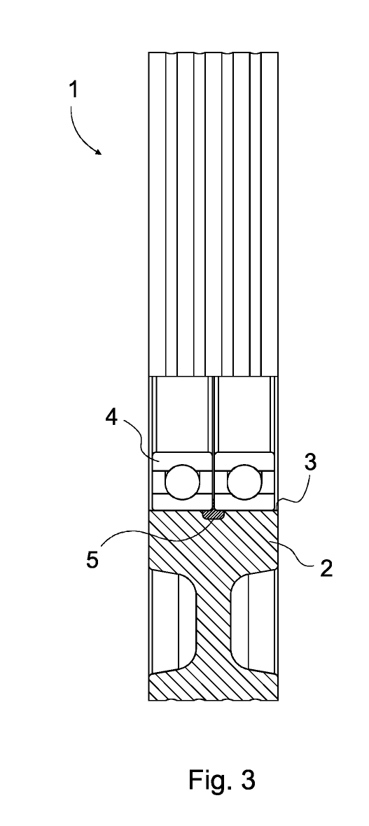

FIG. 3 presents one cast diverting pulley according to the invention, which is provided with rope grooves, as viewed from the side and with the bottom part cross-sectioned,

FIG. 4 presents one detail in the bearing system of the solution according to FIG. 3, as viewed from the side and cross-sectioned,

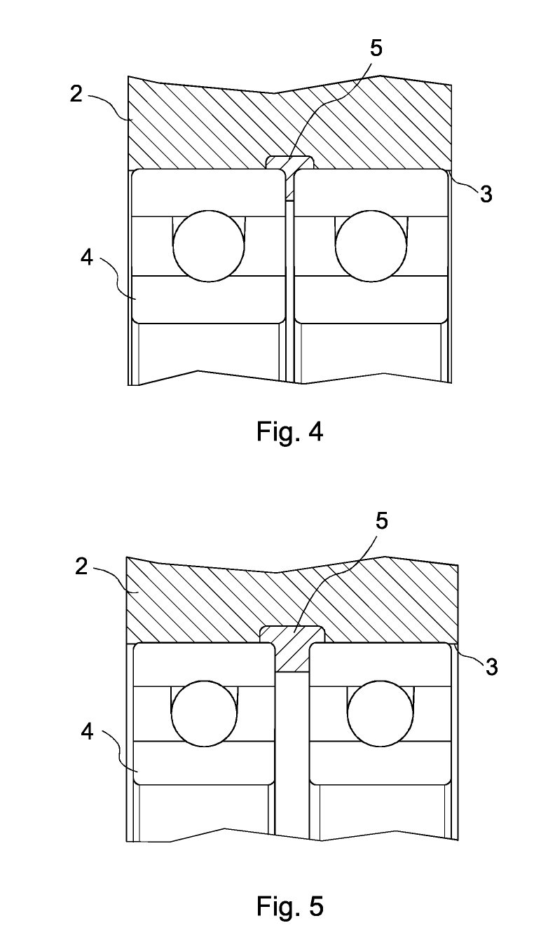

FIG. 5 presents one alternative detail in the bearing system of the solution according to the invention, as viewed from the side and cross-sectioned,

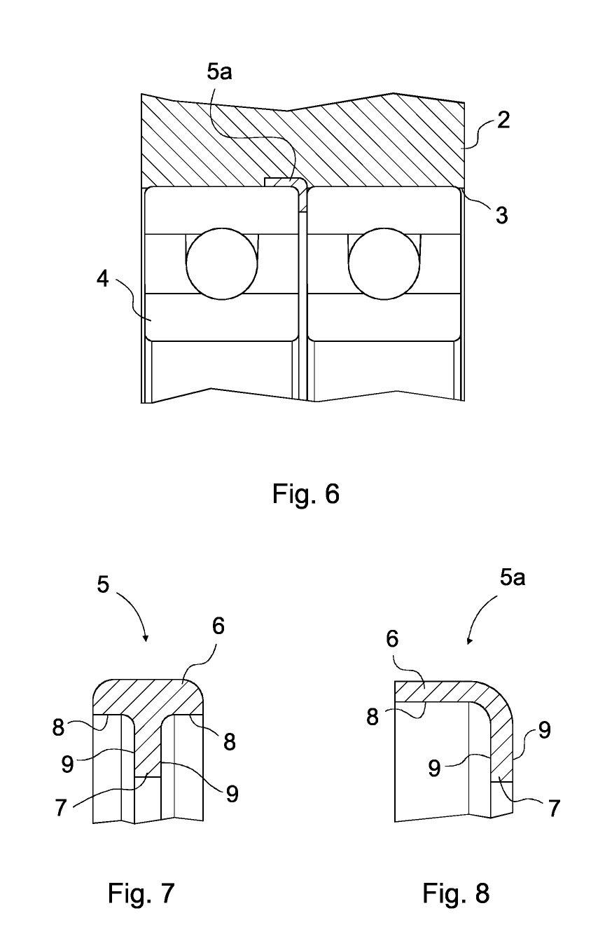

FIG. 6 presents a second alternative detail in the bearing system of the solution according to the invention, as viewed from the side and cross-sectioned,

FIG. 7 presents a side view of a spacer ring type according to FIGS. 3-5, cross-sectioned and magnified, and

FIG. 8 presents a side view of a spacer ring type according to FIG. 6, cross-sectioned and magnified.

FIGS. 3-5 and 7 present a front view of one type of solution according to the invention in connection with a double bearing. FIG. 3 contains a cast diverting pulley 1 provided with rope grooves on its outer rim, the bottom part of which diverting pulley is cross-sectioned for illustrative reasons so that half the double bearing 4 is visible. The diverting pulley 1 comprises a hub 2, which comprises a center hole 3 for the aforementioned double bearing 4. The double bearing 4 comprises two bearing units that are essentially similar, e.g. ball bearings, which are placed side-by-side to each other. A ring-like separator means 5 is disposed between the ball bearings, which separator means comprises a support part 6, which is fitted to support both the ball bearings by their outer rim, and a separator part 7, which is fitted to extend inwards between the bearings towards the axis of rotation of the bearings such that a gap of the thickness of the separator part 7 remains between the ball bearings.

The inner surface of the support part 6 of the separator means 5, which is essentially symmetrical in its cross-sectional shape, i.e. the surface on the bearing side, comprises support surfaces 8 essentially in the direction of the axis of rotation of the bearings, one on both sides of the separator part 7. Correspondingly, the separator part 7 comprises a side support surface 9 on both sides, which side support surface is essentially at a right angle with respect to the axis of rotation of the bearings, i.e. in the direction of the side surfaces of the rims of the bearings, and is fitted to rest on the side surfaces that face each other of the outer rims of the bearings.

FIGS. 6 and 8 present a cross-sectioned front view of a second solution according to the invention in connection with a double bearing. In this solution a ring-like separator means 5a is fitted between the ball bearings, which separator means is shaped like a capital L in its cross-section and comprises a support part 6 and a separator part 7, and which separator means is fitted to extend inwards between the bearings towards the axis of rotation of the bearings such that a gap of the thickness of the separator part 7 remains between the ball bearings. A difference here with respect to the solution described earlier is that the support part 6 is fitted to support only one of the ball bearings of the double bearing by its outer rim.

The inner surface of the support part 6 of the separator means 5a, i.e. the surface on the bearing side, comprises a support surface 8, essentially in the direction of the axis of rotation of the bearings, on one side of the separator part 7. Correspondingly, the separator part 7 comprises a side support surface 9 on both sides, which side support surface is essentially at a right angle with respect to the axis of rotation of the bearings, i.e. is essentially in the direction of the side surfaces of the rims of the bearings, and is fitted to rest on the side surfaces that face each other of the outer rims of the bearings.

The length of the separator part 7 in the radial direction, i.e. the reach in the direction of the side surfaces of the bearings, i.e. the difference in the radius of the support surface 8 and the radius of the centre hole of the separator means 5, 5a can vary, but what is essential is that the reach does not extend to the inner rim of the bearings. Preferably the reach is shorter than the thickness of the outer rim of the bearing in the radial direction.

Also the thickness of the separator part 7 can vary, as is presented by way of example in FIGS. 4, 5 and 6. In this case the bearing pair 4 can be used also in wider wheels or corresponding elements. In order for the separation between the bearing pair 4 to work reliably, the minimum thickness of the separator part 7 must, however, be of a determined magnitude. A minimum thickness that is sufficiently safe is larger than two times the width tolerance of the bearing, i.e. L>2*t, where L=the thickness of the separator part and t=the width tolerance of the bearing.

The material of the separator means 5, 5a can be metal, plastic or some other suitable material. It can also be of such a material that the separator means 5, 5a melts in connection with the casting into the material of the wheel 1 to be cast. In this case it can be e.g. of essentially the same material as the casting to be cast, e.g. a wheel 1.

The separator means 5 settles into its position best when its cross-section is such that only the side support surfaces 9 and the support surface/support surfaces 8 rest on the outer rim of the bearing. In this case, the inner corner between the side support surface 9 and the support surface 8 does not rest on the outer corner of the bearing but instead a gap remains between. In this case e.g. the inner corner between the side support surface 9 and the support surface 8 of the separator means 5 can be a right angle or e.g. extended inwards from the shear plane between the side support surface 9 and the support surface 8 such that the thickness of the separator part 7 of the separator means 5 and the thickness of the support part 6 is thinner at the point of the inner corner than at the point of the support surfaces 8 and the side support surfaces 9.

With the method according to the invention, the double bearing is installed in a casting e.g. as follows: first a double bearing 4 is formed of two essentially similar ball bearings, i.e. bearing units, by disposing the ball bearings next to each other side-by-side and by placing a separator means 5, 5a between the ball bearings such that the separator means 5, 5a rests on at least one of or on both the outer surfaces of the outer rim of the bearing and the separator part 7 of the separator means 5, 5a is disposed between the side surfaces that face each other of the outer rims. Thus by means of the separator means 5, 5a, a gap is formed between the ball bearings in their axial direction, which gap prevents the inner rims of the ball bearings from touching each other.

The double bearing 4 formed in the manner described above is after this placed in the casting mold in the correct position and the casting, such as a wheel, is cast around the double bearing 4, in which case the double bearing 4 remains in its position in the hub of the wheel 1 after the casting is completed. The separator part 7 of the separator means 5, 5a keeps the ball bearings separate from each other during the casting and at the same time prevents casting material from entering the inner parts of the bearings from between the outer rims of the bearings.

It is obvious to the person skilled in the art that different embodiments of the invention are not limited to the example described above, but that they may be varied within the scope of the claims presented below. Thus for instance the sequence and number of phases of the method can differ to what is presented above.

It is also obvious to the skilled person that other bearings can be used, such as e.g. roller bearings, instead of ball bearings.

It is further obvious to the person skilled in the art that the cross-sectional shape of the separator means can be different to what is described above.

1. A method for installing a double bearing in a casting, which double bearing comprises at least two bearing units that are essentially similar to each other, wherein the method comprises the steps of:
forming a double bearing by disposing two bearings next to each other side-by-side and by placing a separator that forms a gap between the bearings such that the separator rests on the outer surface of the outer rim of at least one bearing and the separator part of the separator is disposed between the side surfaces that face each other of the outer rims of the bearings;
placing the formed double bearing in the casting mold in the correct position; and
casting around the double bearing.

2. The method according to claim 1, wherein before casting, the separator is supported on the outer surface of the outer rim of both bearings and the separator part of the separator is disposed between the side surfaces that face each other of the outer rims of the bearings.

3. The method according to claim 1, wherein the casting is cast around the double bearing as a diecast.

4. The method according to claim 1, wherein the separator is arranged to melt or to soften at least partly and the separator is allowed to harden again as the casting hardens.

5. A wheel comprising at least a hub, which comprises a center hole, into which a double bearing is disposed, wherein bearing units of the double bearing are separated from each other in the axial direction by means of a separator resting against an outer surface of an outer rim of at least one bearing.

6. The wheel according to claim 5, wherein a ring-like separator is disposed between the bearing units of the double bearing, which separator comprises a support part, which is fitted to support both the bearing units by their outer rim, and a separator part, which is fitted to extend inwards between the bearing units towards the axis of rotation of the bearings such that a gap of the thickness of the separator part remains between the bearing units.

7. The wheel according to claim 5, wherein the separator is essentially symmetrical in cross-section and the surface of the support part of the separator on the bearing side comprises support surfaces essentially in the direction of the axis of rotation of the bearings, one on both sides of the separator part.

8. The wheel according to claim 5, wherein a ring-like separator is disposed between the bearing units of the double bearing, which separator comprises a support part, which is fitted to support one of the bearing units by its outer rim, and a separator part, which is fitted to extend inwards between the bearing units towards the axis of rotation of the bearings such that a gap of the thickness of the separator part remains between the bearing units.

9. The wheel according to claim 5, wherein the separator part comprises a side support surface on both sides, which side support surface is essentially in the direction of the side surfaces of the rims of the bearings and is fitted to rest on the side surfaces that face each other of the outer rims of the bearings.

10. The wheel according to claim 5, wherein the radial reach of the separator part in the direction of the side surfaces of the bearings is shorter than the thickness of the outer rim of the bearing in the radial direction.

11. The wheel according to claim 5, wherein the thickness of the separator part is larger than twice the width tolerance of the bearing.

12. The wheel according to claim 5, wherein the separator is of essentially the same material as the casting cast around the double bearing.

13. The wheel according to claim 5, wherein the separator is fitted to prevent casting material from entering the gap between the bearing units of the double bearing via the outer rims of the bearings.

14. The wheel according to claim 5, wherein the separator comprises material hardened together with the casting material of the wheel.

15. A joint comprising a bearing hole in a jointed piece, into which hole a double bearing is disposed, wherein the bearing units of the double bearing are separated from each other in the axial direction by the aid of a separator resting against an outer surface of an outer rim of at least one bearing.

16. The method according to claim 2, wherein the casting is cast around the double bearing as a die-cast.

17. The method according to claim 2, wherein the separator is arranged to melt or to soften at least partly and the separator is allowed to harden again as the casting hardens.

18. The method according to claim 3, wherein the separator is arranged to melt or to soften at least partly and the separator is allowed to harden again as the casting hardens.

19. The wheel according to claim 6, wherein the separator is essentially symmetrical in cross-section and the surface of the support part of the separator on the bearing side comprises support surfaces essentially in the direction of the axis of rotation of the bearings, one on both sides of the separator part.

20. The wheel according to claim 6, wherein the separator part comprises a side support surface on both sides, which side support surface is essentially in the direction of the side surfaces of the rims of the bearings and is fitted to rest on the side surfaces that face each other of the outer rims of the bearings.
